(19) United States
(12) Patent Application Publication
(10) Pub. No.: US 2026/0340238 A1
(43) Pub. Date: Oct. 29, 2026

(54) SIMULATION APPARATUS AND PROGRAM

(71) Applicant: FANUC CORPORATION, Yamanashi (JP)

(72) Inventor: Kouya YAMAMOTO, Yamanashi (JP)

(21) Appl. No.: 19/122,260

(22) PCT Filed: Oct. 27, 2022
(86) PCT No.: PCT/JP2022/040200

§ 371 Date: Apr. 18, 2025

(51) Int. Cl. G06F 30/28; G06F 113/08

(52) U.S. Cl. CPC G06F 30/28; G06F 2113/08

(57) ABSTRACT

A simulation apparatus according to an aspect of the present disclosure includes a storage unit for storing a 3D model of a workpiece to be cleaned, a reception unit for receiving a user operation for causing dirt to be expressed on entirety or part of the 3D model of the workpiece, a creation unit for creating, based on a user operation, a dirt adhering model in which the dirt is expressed on the entirety or part of the 3D model of the workpiece, and a display unit for displaying the created dirt adhering model.

### RELATED APPLICATIONS

The present application is a National Phase of International Application No. PCT/JP 2022/040200 filed Oct. 27, 2022.

### TECHNICAL FIELD

The present disclosure relates to a simulation apparatus having a cleaning operation simulation function and a program.

### BACKGROUND ART

As a method for teaching a predetermined operation to a robot, an on-line teaching method, an off-line teaching method, and the like have been proposed. For example, a simulation-based teaching method is known as the off-line teaching method. In simulation-based off-line teaching, 3D models of a robot, an end effector, a workpiece, a peripheral device, and the like are placed in a virtual space displayed on a PC, and an operation program can be created while virtually operating these models. Simulation-based off-line teaching is widely used because there is no need to operate the actual machine, and a program can by be created and checked by simulation anytime and anywhere with a PC. In the simulation-based off-line teaching, for example, the user can create an operation program for causing a robot to execute an operation such as a picking operation, an assembling operation, a welding operation, a coating operation, or the like while actually operating a robot model on a screen and confirming the operation. On the other hand, for example, when creating a cleaning program for a robot to execute a cleaning operation, it is difficult to reproduce the cleaning operation by simulation because “dirt” cannot be reproduced on the simulation. Therefore, the user creates a cleaning program while imagining that dirt is adhered to the target workpiece, and then actually operates the cleaning robot in accordance with the created cleaning program to confirm whether the target workpiece is properly cleaned. As described above, since the creation of the cleaning program cannot be completed only by simulation, it requires a lot of time. As a technique related to such a cleaning operation, Patent Literature 1 discloses a technique of generating a fluid jet path to move debris by jetting fluid in a machine tool.

### CITATION LIST

### Patent Literature

Patent Literature 1: Japanese U.S. Pat. No. 7,083,943

### SUMMARY

### Problem to be Solved

However, the cleaning operation still cannot be reproduced by simulation, and it is desired to propose a technique for reproducing dirt by simulation so that a cleaning program can be created by simulation.

### Solution to Problem

A simulation apparatus according to an aspect of the present disclosure includes a storage unit for storing a 3D model of a workpiece to be cleaned, a reception unit for receiving a user operation for causing dirt to be expressed on entirety or part of the 3D model of the workpiece, a creation unit for creating, based on a user operation, a dirt adhering model in which the dirt is expressed on the entirety or part of the 3D model of the workpiece, and a display unit for displaying the created dirt adhering model.

### BRIEF DESCRIPTION OF THE DRAWINGS

FIG. 1 shows an example of a cleaning robot system.

FIG. 2 is a hardware configuration diagram of a simulation apparatus according to the present embodiment.

FIG. 3 is a functional block diagram of the simulation apparatus according to the present embodiment.

FIG. 4 shows an example of a procedure for creating a cleaning program by the simulation apparatus according to the present embodiment.

FIG. 5 shows an example of the procedure of a process of creating a dirt adhering model in step S11 of FIG. 4.

FIG. 6 shows an example of a setting screen of a method for expressing dirt on a dirt adhering model.

FIG. 7 shows a display example of dirt expressed by a dirt model.

FIG. 8 shows a display example of dirt expressed by a change in the surface of a cleaning target model.

FIG. 9 is a diagram for explaining a method for setting a dirt range using an image.

FIG. 10 shows a reference model of dirt in a corner portion.

FIG. 11 shows a dirt adhering model in which the dirt reference model is applied to a corner portion of a cleaning target model.

FIG. 12 shows a fluid jet model.

FIG. 13A and FIG. 13B are diagrams for explaining a dirt subtraction process during execution of a simulation.

FIG. 14 shows an example of a dirt adhering model before execution of a simulation.

FIG. 15 shows an example of a dirt adhering model after execution of a simulation.

FIG. 16 shows another example of a dirt adhering model after execution of a simulation.

FIG. 17 shows another example of a dirt adhering model after execution of a simulation.

FIG. 18 shows another example of the procedure for creating a cleaning program by the simulation apparatus according to the present embodiment.

FIG. 19 is a flowchart showing an example of a procedure of a process of automatically registering a teaching point in step S26 of FIG. 18.

FIG. 20 is a diagram for explaining another example of the process of automatically registering a teaching point.

### DETAILED DESCRIPTION

Hereinafter, a simulation apparatus according to the present embodiment will be described with reference to the drawings. In the following description, constituent elements having substantially the same function and configuration are denoted by the same reference numeral, and repetitive descriptions will be given only where necessary.

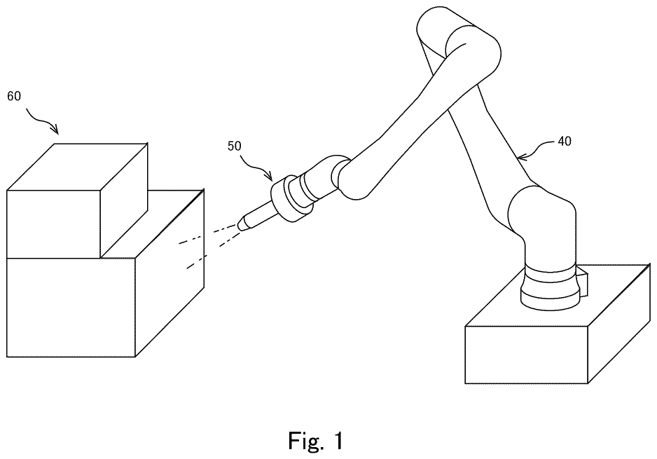

As shown in FIG. 1, a simulation apparatus 1 according to the present embodiment is a computer apparatus having a function of creating, by simulation, a cleaning program for causing a cleaning robot 40 having a cleaning nozzle 50 to execute a cleaning operation on a workpiece 60 to be cleaned. Specifically, the simulation apparatus 1 has a function of creating a 3D model (dirt adhering model) in which dirt is reflected on a 3D model (cleaning target model) of a workpiece 60 to be cleaned, a function of arranging the dirt adhering model and a 3D model (cleaning robot model) of a cleaning robot 40 in a virtual space, a function of teaching a cleaning program to the cleaning robot model arranged in the virtual space, a function of creating a cleaning program that summarizes the contents taught to the cleaning robot model, and a function of causing the cleaning robot model to execute a cleaning operation by simulation in accordance with the created cleaning program. Typically, the simulation apparatus 1 according to the present embodiment is configured as follows.

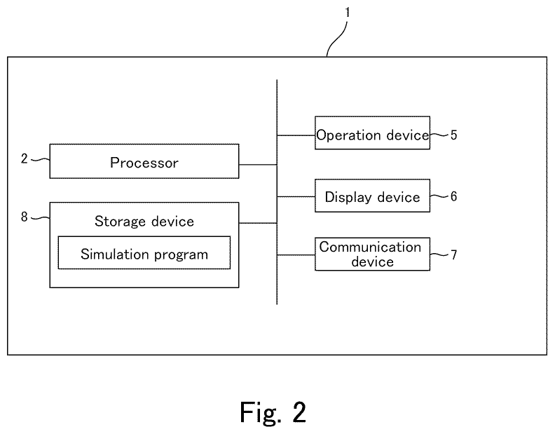

As shown in FIG. 2, the simulation apparatus 1 according to the present embodiment is configured by connecting hardware such as an operation device 5, a display device 6, a communication device 7, and a storage device 8 to a processor 2 (a CPU, etc.). The simulation apparatus 1 is provided by a general information processing terminal such as a personal computer, a tablet, or a smartphone.

The operation device 5 is provided by a keyboard, a mouse, a jog, or the like. The operation device 5 may be provided by a touch panel that also serves as the display device 6. The user can input various types of information to the simulation apparatus 1 through the operation device 5. The display device 6 is provided by an LCD or the like. A screen created by a screen creation unit 22 is displayed on the display device 6. The communication device 7 controls transmission and reception of data to and from a controller or the like of a robot. A cleaning program created by the simulation apparatus 1 is transmitted to a robot controller by the processing of the communication device 7. The storage device 8 is provided by an HDD, an SSD, or the like. A simulation program is stored in the storage device 8.

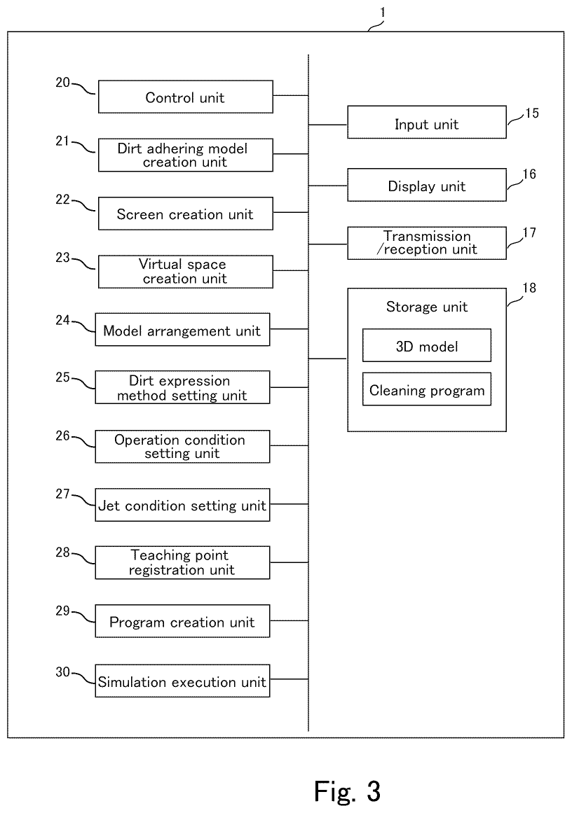

When the simulation program stored in the storage device 8 is executed by the processor 2, as shown in FIG. 3, the simulation apparatus 1 functions as an input unit (reception unit) 15, a display unit 16, a transmission/reception unit 17, a storage unit 18, a dirt adhering model creation unit 21, a screen creation unit 22, a virtual space creation unit 23, a model arrangement unit 24, a dirt expression method setting unit 25, an operation condition setting unit 26, a jet condition setting unit 27, a teaching point registration unit 28, a program creation unit 29, and a simulation execution unit (jet amount calculation unit) 30.

The input unit 15 is an interface for directly inputting a user operation to the simulation apparatus 1. In the present embodiment, the input unit 15 inputs a user operation via the operation device 5 to the simulation apparatus 1. The display unit 16 has the display device 6 shown in FIG. 2, and displays the screen created by the screen creation unit 22. The transmission/reception unit 17 is an interface for transmitting and receiving data to and from a device connected thereto by wire or wirelessly. In the present embodiment, the transmission/reception unit 17 transmits and receives data to and from the robot controller via the communication device 7 shown in FIG. 2. Note that user operations may be input from an external information processing terminal or the like. In this case, the transmission/reception unit 17 functions as the reception unit.

The storage unit 18 has the storage device 8 shown in FIG. 2. Data of 3D models are stored in advance in the storage unit 18. The data of 3D models includes a cleaning robot model including a cleaning nozzle model, and a cleaning target model.

The dirt adhering model creation unit 21 uses the data of the cleaning target model stored in the storage unit 18 to create a dirt adhering model in which dirt is reflected on the cleaning target model.

The screen creation unit 22 creates various screens related to the creation of the cleaning program. The various screens include a teaching screen for teaching a cleaning program to a cleaning robot model, a setting screen for setting a dirt expression method, a setting screen for setting an operation condition, a setting screen for setting a jet condition of fluid jetted from a cleaning nozzle, a creation screen for creating a dirt adhering model, and the like.

The virtual space creation unit 23 creates a virtual space on software that three-dimensionally represents the operation space of the cleaning robot. The virtual space created by the virtual space creation unit 23 is displayed on the teaching screen or the like created by the screen creation unit 22.

The model arrangement unit 24 arranges the cleaning robot model and the dirt adhering model in the virtual space created by the virtual space creation unit 23. The cleaning robot model and the dirt adhering model are arranged in the virtual space so as to correspond to the positional relationship between the cleaning robot and the dirt adhering workpiece in the actual operation space.

The dirt expression method setting unit 25 sets a dirt expression method based on a user operation on the dirt expression method setting screen. Details of the dirt expression method will be described later. The operation condition setting unit 26 sets an operation condition of the cleaning robot model based on a user operation on the setting screen for setting an operation condition. As the operating condition of the cleaning robot model, a known parameter such as an operation speed, an interpolation format, or a movement format can be adopted. The operating condition may be fixed or varied during the operation of the cleaning robot model. The jet condition setting unit 27 sets a jet condition of fluid based on a user operation on the jet condition setting screen. The jet condition may be fixed during the cleaning operation or varied depending on the cleaning position. Details of the jet condition will be described later.

The teaching point registration unit 28 registers the position of the hand reference point and the hand posture of the cleaning robot model as a teaching point by a user operation on the teaching screen which includes the virtual space in which the cleaning robot model and the dirt adhering model are arranged. For example, the position of the hand reference point is set to the tip position of the cleaning nozzle model of the cleaning robot model.

The program creation unit 29 creates a cleaning program based on the operation condition set by the operation condition setting unit 26, the jet condition set by the jet condition setting unit 27, and the plurality of teaching points registered by the teaching point registration unit 28.

The simulation execution unit 30 executes a simulation operation for simulatively operating the cleaning robot model arranged in the virtual space in accordance with the cleaning program or in accordance with a user operation input via the operation device 5. Specifically, the simulation execution unit 30 executes a movement simulation of the cleaning robot model 70 and a fluid jet simulation. In the fluid jet simulation, the simulation execution unit 30 calculates the amount of fluid jetted to each part of the dirt adhering model, and subtracts the amount of fluid jetted from the dirt degree of the dirt model or the dirt range of the dirt adhering model, thereby calculating the degree of dirt removed from the dirt model or the dirt range and the degree of dirt remaining thereon.

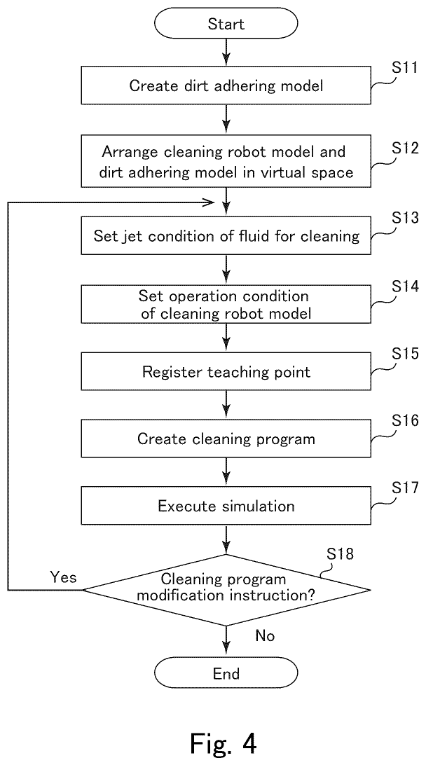

A procedure for creating the cleaning program using the simulation apparatus 1 according to the present embodiment will be described below with reference to FIG. 4.

As shown in FIG. 4, the simulation apparatus 1 creates a dirt adhering model based on a user operation (S11), and arranges the created dirt adhering model and the cleaning robot model in the virtual space displayed on the teaching screen (S12). Next, the simulation apparatus 1 sets the jet condition of the fluid jetted from the cleaning nozzle model provided in the cleaning robot model (S13), and sets the operation condition of the cleaning robot model (S14), based on a user operation. Next, the simulation apparatus 1 registers a teaching point based on a user operation on the teaching screen (S15). The simulation apparatus 1 creates a cleaning program based on the jet condition set in step S13, the operation condition set in step S14, and the teaching point registered in step S15 (S16). Then, the simulation apparatus 1 causes the cleaning robot model arranged in the virtual space to execute simulation of a cleaning operation based on the cleaning program created in step S16 (S17). The processes of steps S13 to S17 are repeatedly executed until the user completes a modification operation of the cleaning program (S18; Yes). When the user finishes the modification operation of the cleaning program, the creation of the cleaning program is completed (S18; No).

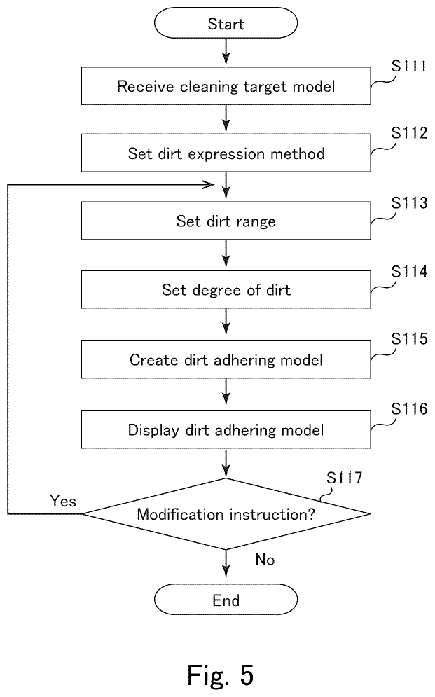

The process of creating the dirt adhering model of step S11 in FIG. 4 will be described below with reference to FIG. 5. The dirt adhering model is created by the dirt adhering model creation unit 21. As shown in FIG. 5, the simulation apparatus 1 sets the cleaning target model and the dirt expression method based on a user operation (S111, S112). Next, the simulation apparatus 1 sets the range where dirt is reflected and the degree of dirt based on a user operation on the cleaning target model (S113, S114). Then, the simulation apparatus 1 creates (S115) and displays (S116) a dirt adhering model in which the dirt of the degree of dirt set in step S114 is reflected in the range set in step S113 on the cleaning target model using the expression method set in step S112. The processes of steps S112 to S116 are repeatedly executed until the user completes the modification operation of the dirt adhering model (S117; Yes). When the user finishes the modification operation on the dirt adhering model, the creation of the dirt adhering model is completed (S117; No).

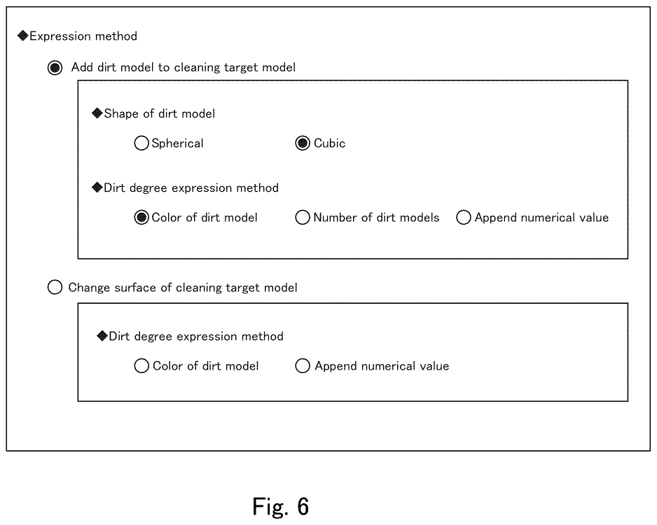

The dirt expression method of step S112 in FIG. 5 will be described below with reference to FIG. 6. FIG. 6 shows an example of the setting screen of the dirt expression method. The setting screen of the dirt expression method is configured so that the user can set the dirt expression method of the cleaning target model on the simulation. As shown in FIG. 6, a plurality of options for selecting the dirt expression method are displayed on the setting screen. The options for the dirt expression method include “adding a dirt model to the cleaning target model” and “changing the surface of the cleaning target model”. “Adding a dirt model to the cleaning target model” is a method of expressing dirt of the cleaning target model by overlaying a dirt model, which is modeled on dirt, as a separate entity from the cleaning target model, on the surface of the cleaning target model. “Changing the surface of the cleaning target model” is a method of expressing dirt as a change in the surface of the cleaning target model, not as an object like the dirt model.

In order to set the details of the dirt expression method “adding a dirt model to the cleaning target model”, a plurality of options for selecting the shape of the dirt model and a plurality of options for selecting the expression method of the degree of dirt are displayed on the setting screen. The options for the shape of the dirt model include “spherical” and “cubic” shapes. The shape of the dirt model is not limited to these, and any shape such as a rectangular parallelepiped shape, an ellipsoid shape, or a prolate spheroid shape can be adopted. The options for the expression method of the degree of dirt include “color of dirt model”, “number of dirt models”, and “append numerical value”. The expression method of the degree of dirt is not limited to these, and a pattern and the like can be adopted.

In order to set the details of the dirt expression method “changing the surface of the cleaning target model”, a plurality of options for selecting the expression method of the degree of dirt are displayed on the setting screen. The options for the expression method of the degree of dirt include “color of dirt model” and “append numerical value”. Note that the degree of dirt is expressed by the jet amount of fluid required to remove the dirt. The dirt that is assumed to be removed by the jet amount of 3 ml is worse than the dirt that is assumed to be removed by the jet amount of 1 ml. Of course, the degree of dirt may involve not only the jet amount of fluid but also other parameters such as the jet pressure. Further, since the cleaning power varies depending on the type of fluid, the type of fluid may also be involved in the degree of dirt.

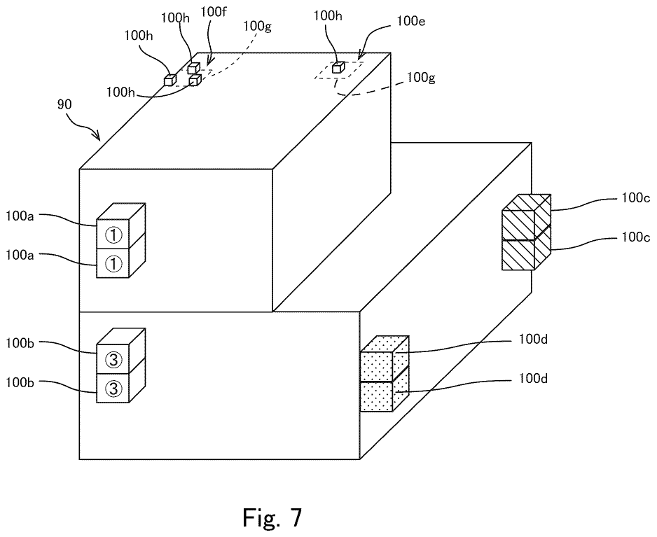

Referring to FIG. 7, the dirt expression method “adding a dirt model to the cleaning target model” will be described below. In FIG. 7, the dirt model is shown together with the cleaning target model. Here, the dirt model 100 is assumed to have a cubic shape. The size of the dirt model 100 (the area of one face of a cube) corresponds to the dirt range represented by one dirt model 100. The center position of the dirt model 100 corresponds to the center position of the dirt range represented by the dirt model 100. As shown in FIG. 7, in the dirt expression method “adding a dirt model to the cleaning target model”, the dirt model 100 is displayed on the surface of the cleaning target model 90. The dirt models 100a and 100b each represent the degree of dirt by a numerical value. The dirt model 100a with the numerical value “1” appended represents dirt that is assumed to be removed by jetting 1 ml of fluid to the location where the dirt model 100a is placed. Similarly, the dirt model 100b with the numerical value “3” appended represents dirt that is assumed to be removed by jetting 3 ml of fluid to the location where the dirt model 100b is placed. Each of the dirt models 100a and 100b, which represents the degree of dirt by a numerical value, allows the user to quantitatively grasp the degree of dirt removed and the amount of dirt remaining, as how the dirt is removed is expressed by a countdown of the degree of dirt by fluid being jetted through cleaning simulation.

The dirt models 100c and 100d each represent the degree of dirt by color. For example, the dirt model 100c represents dirt that is assumed to be removed by jetting 1 ml of fluid at the location where the dirt model 100c is placed, and the dirt model 100d represents dirt that is assumed to be removed by jetting 3 ml of fluid at the location where the dirt model 100d is placed. Each of the dirt models 100c and 100d, which represents the degree of dirt by color, allows the user to quantitatively grasp the degree of dirt removed and the amount of dirt remaining, as how the dirt is removed is expressed by a change in color by fluid being jetted through cleaning simulation. Note that the transparency of the dirt model may be changed depending on the degree of dirt. For example, the degree of transparency is defined such that the higher the degree of dirt, the lower the degree of transparency, and the zero or lower the degree of dirt, the higher the degree of transparency.

The dirt models 100e and 100f represent the degree of dirt by the number of models. The dirt model 100 e, which has one dirt model 100h per reference range 100g, represents dirt that is assumed to be removed by jetting 1 ml of fluid to the location where the reference range is located.

Similarly, the dirt model 100 f, which has three dirt models 100h per reference range 100g, represents dirt that is assumed to be removed by jetting 3 ml of fluid to the location where the reference range is located. The dirt models 100e and 100f allow the user to quantitatively grasp the degree of dirt removed and the amount of dirt remaining, as how the dirt is removed is expressed by a change in the number of dirt models 100h by fluid being jetted through cleaning simulation.

The user can select a dirt expression method according to his or her preference.

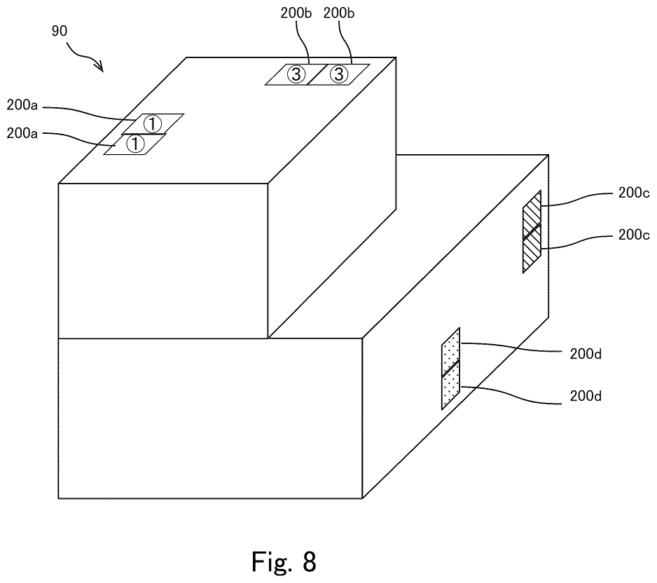

Referring to FIG. 8, the dirt expression method “changing the surface of the cleaning target model” will be described below. FIG. 8 is a diagram showing the dirt model together with the cleaning target model. As shown in FIG. 8, in the dirt expression method “changing the surface of the cleaning target model”, the dirt range where dirt is to be reflected on the surface of the cleaning target model is set. The dirt range is divided into a plurality of partial ranges. For example, the shape of each partial range is set to a square shape. For example, when the area of the dirt range is 15 cm² and the area of the partial range is 1cm² , the dirt range is divided into 15 partial ranges. Each of the dirt partial ranges 200a and 200b, which expresses the degree of dirt in a numerical value, allows the user to quantitatively grasp the degree of dirt removed and the amount of dirt remaining, as how the dirt is removed is expressed by a countdown of the degree of dirt by fluid being jetted through cleaning simulation.

Each of the dirt partial ranges 200a and 200b represents dirt whose degree of dirt is expressed by a numerical value. The dirt range 200a, marked with the numerical value “1”, represents dirt that is assumed to be removed by jetting 1 ml of fluid to the center position of the dirt partial range. Similarly, the dirt partial range 200b, marked with the numerical value “3”, represents dirt that is assumed to be removed by jetting 1 ml of fluid to the center position of the dirt partial range. The dirt partial ranges 200c and 200d each represent a dirt model whose degree of dirt is expressed by color. For example, the dirt partial range 200c represents dirt that is assumed to be removed by jetting 1 ml of fluid to the center position of the dirt partial range, and the dirt partial range 200d represents dirt that is assumed to be removed by jetting 3 ml of fluid to the center position of the dirt partial range. Each of the dirt partial ranges 200c and 200d, which expresses the degree of dirt by color, allows the user to quantitatively grasp the degree of dirt removed and the amount of dirt remaining, as how the dirt is removed is expressed by a change in color by fluid being jetted through cleaning simulation. For example, when the surface color of the cleaning target model is the first color and the color of the dirt partial range 200 is the second color, the color of the dirt range 200 is changed from the second color to gradually approach the first color based on the amount of jet to the dirt partial range. The color change at this time is preferably expressed by a gradation. This allows the user to intuitively grasp how the dirt is removed.

For example, the user designates the dirt range and the degree of dirt through an operation on the cleaning target model, thereby creating a dirt adhering model in which the surface of the cleaning target model corresponding to the designated dirt range has been changed to a mode representing the designated degree of dirt.

Note that as the method of designating the dirt range, any method can be adopted, such as a dot, a line, or a band. It is also possible to collectively designate the entire cleaning target model as the dirt range. For example, an icon of a pen, a brush, or the like may be displayed as a tool for designating the dirt range on the screen for creating the dirt adhering model. Accordingly, the user can designate the dirt range where dirt is to be reflected on the cleaning target model by an intuitive operation using the tool.

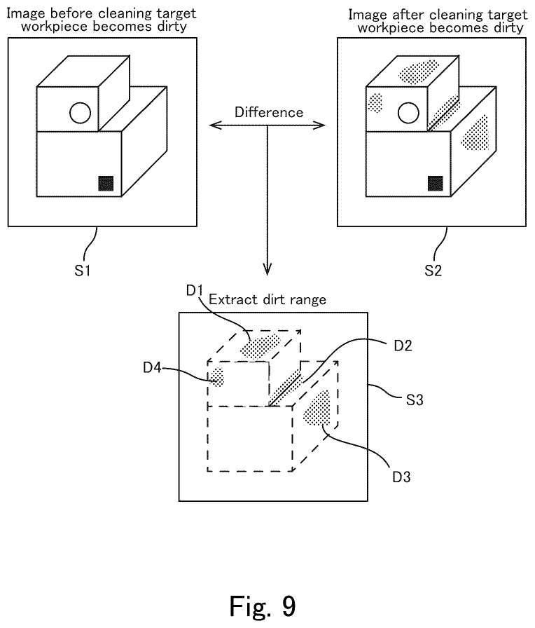

Also, as shown in FIG. 9, a difference image S3 is created by image processing (difference processing) on an image S1 before the cleaning target workpiece becomes dirty and an image S2 after it becomes dirty, dirt ranges D1 to D4 are extracted, and the extracted dirt ranges D1 to D4 can be set as the dirt ranges of the cleaning target model. Of course, the degree of dirt may be identified based on the pixel value, etc. of the dirt range by image processing on the image S1 before the cleaning target workpiece becomes dirty and the image S2 after it becomes dirty, and the identified degree of dirt may be adopted as the degree of dirt at the cleaning target model.

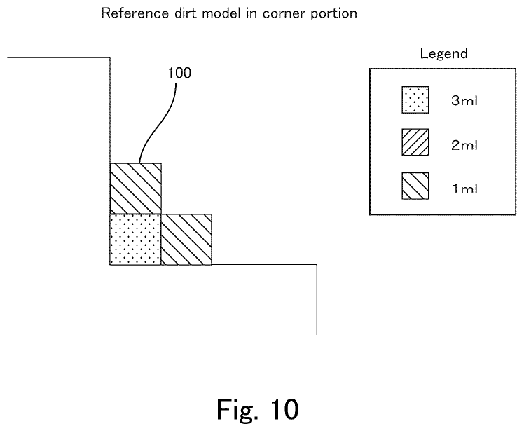

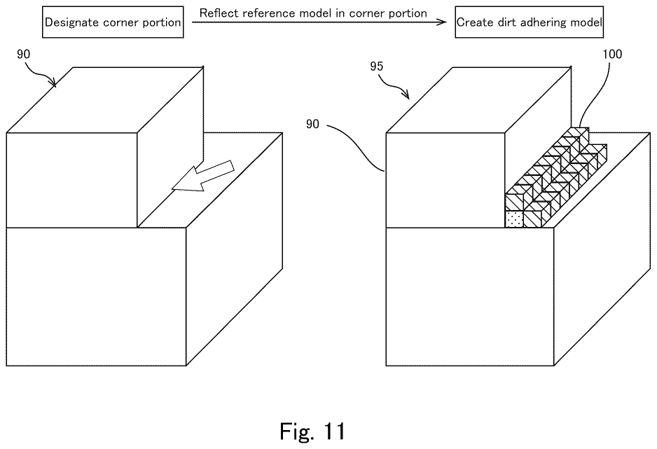

It is also possible to create a reference model corresponding to each portion where dirt is to be reflected, and automatically reflect, in a portion designated by the user, the reference model corresponding to the portion. FIG. 10 is a diagram showing a reference model of dirt in a corner portion. FIG. 11 is a diagram showing a state in which the reference model is reflected in a corner portion of the cleaning target model. As shown in FIG. 11, when a corner portion of the cleaning target model 90 is designated by a user operation, the reference model of dirt in the corner portion shown in FIG. 10 is read and applied throughout the corner portion. As described above, by creating a reference model of dirt for each part where dirt is to be reflected and for each type of the workpiece to which dirt is to be reflected, the user can reflect dirt on the cleaning target model 90 by a simple operation, so that the time required to create the dirt adhering model 95 can be shortened.

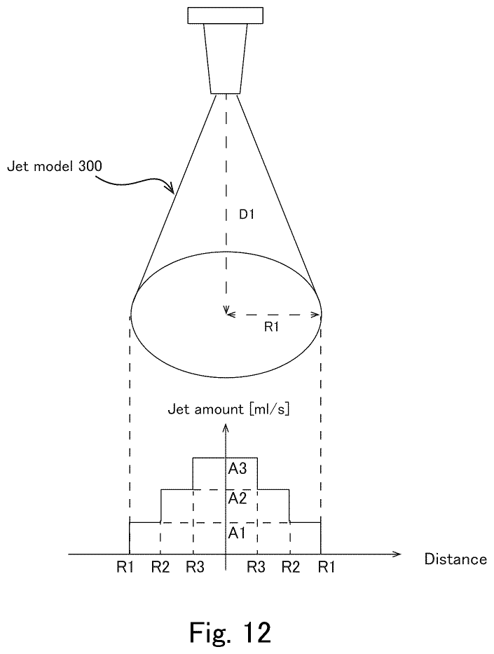

The jet condition in step S13 of FIG. 3 will be described below with reference to FIG. 12. FIG. 12 shows a state where fluid is jetted from the jet nozzle model. As the fluid, compressed air, water, cleaning liquid or the like can be employed. As shown in FIG. 12, the jet condition includes a distance D1 from the nozzle tip to the cleaning surface and the fluid jet amount distribution at the distance D1. By setting the jet condition, a fluid jet model can be created. For example, the jet amount distribution can be set by a graph having the distance from the jet center as the horizontal axis and the jet amount as the vertical axis. As shown in FIG. 12, the jet amount distribution is set such that the jet amount per unit area of the circular range from the jet center to the distance R1 is A3, the jet amount per unit area of the annular range between the distances R1 and R2 from the jet center is A2, and the jet amount per unit area of the annular range between the distances R2 and R3 from the jet center is A1. In the present embodiment, the jet condition is set by the user in the simulation apparatus 1, but a condition received from another apparatus connected to the simulation apparatus 1 may be set as the jet condition. By moving the jet model by the cleaning robot model, fluid can be virtually jetted to each part of the dirt adhering model.

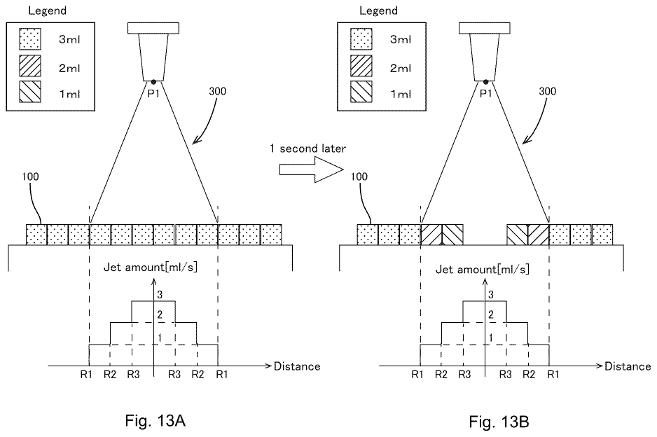

The change in the dirt display mode when the cleaning simulation is executed will be described below with reference to FIG. 13A and FIG. 13B. In FIG. 13A and FIG. 13B, the fluid jet model 300 is shown together with the dirt model 100. FIG. 13A shows the dirt model 100 at the start of cleaning, and FIG. 13B shows the dirt model 100 at one second after the start of cleaning. Here, it is assumed that the dirt model 100 is dirt that is assumed to be removed by jetting 3 ml of fluid. As shown in FIG. 13A, the fluid is jetted to six dirt models 100 with which the jet model interferes. Of the six dirt models 100, the two central dirt models 100 are jetted with fluid at 3 ml per second, the outer dirt models 100 are jetted with fluid at 2 ml per second, and the further outer dirt models 100 are jetted with fluid at 1 ml per second. Therefore, when the cleaning robot model is at rest at the position P1 and fluid is jetted for 1 second, 3 ml of fluid is jetted to dirt that is assumed to be removed by jetting 3 ml of fluid, so that the degrees of dirt of the two central dirt models 100 are subtracted to become 0 and the two central dirt models 100 are deleted. On the other hand, since 2 ml of fluid is jetted to dirt that is assumed to be removed by jetting 3 ml of fluid, the dirt degrees of the dirt models 100 outside the two central dirt models 100 are subtracted, and as a result, the displays are changed from the display mode of dirt that is assumed to be removed by jetting 3 ml of fluid to the display mode of dirt that is assumed to be removed by jetting 1 ml of fluid. Similarly, since 1 ml of fluid is jetted to dirt that is assumed to be removed by jetting 3 ml of fluid, the dirt degrees of the outer dirt models 100 are further subtracted, and as a result, the displays are changed from the display mode of dirt that is assumed to be removed by jetting 3 ml of fluid to the display mode of dirt that is assumed to be removed by jetting 2 ml of fluid. As described above, in the simulation of the cleaning operation, the dirt model 100 can be deleted or the display mode thereof can be changed based on the jet amount of fluid to each part of the dirt adhering model. Specifically, it is possible to calculate how much dirt has been removed by subtracting the amount of jet to the dirt model 100 from the numerical value representing the degree of dirt of the dirt model 100, and to express the degree of dirt removed and the degree of dirt remaining by deleting the dirt model 100 or changing the display mode thereof.

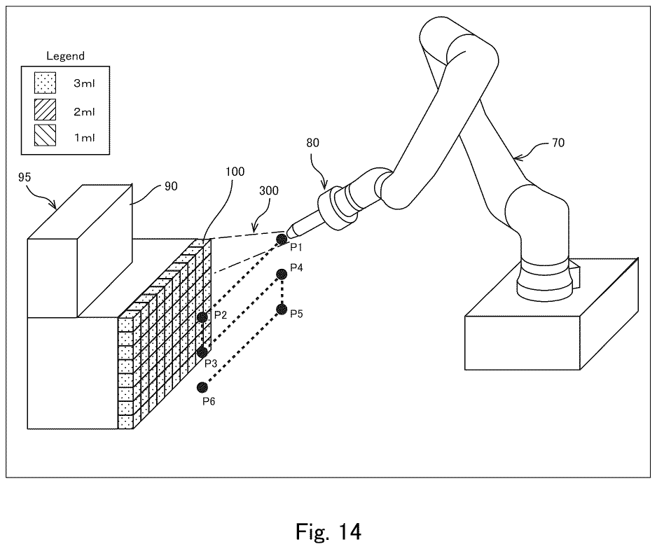

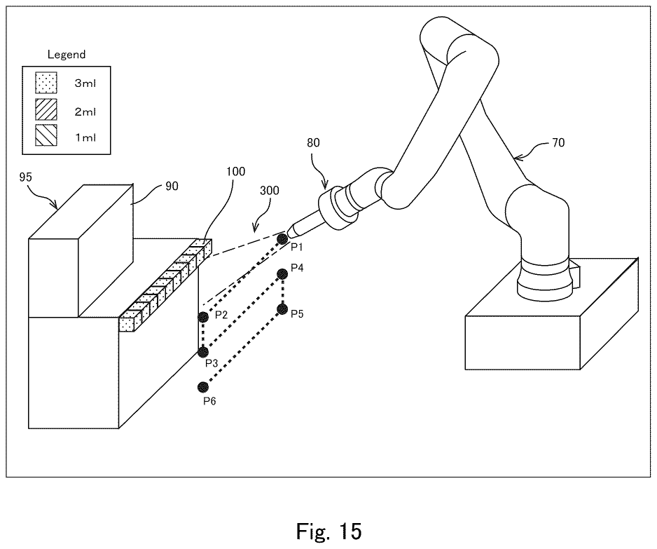

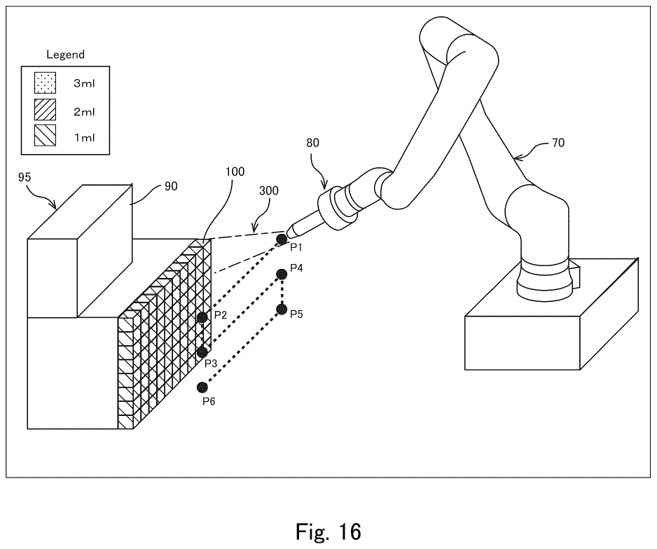

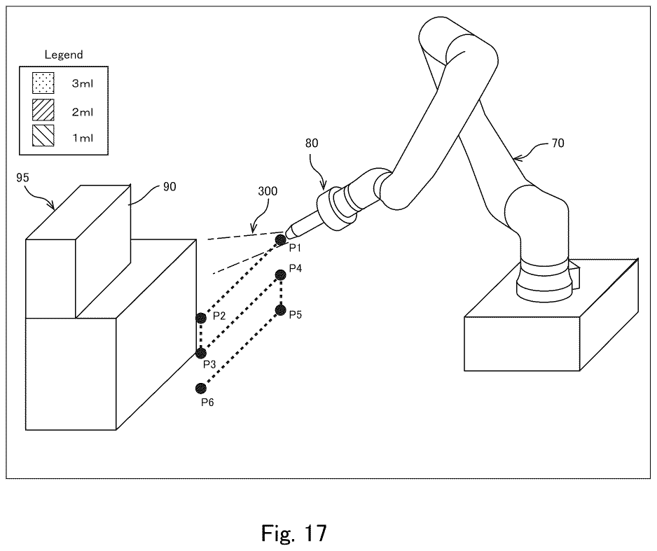

An example of executing simulation using the cleaning robot model 70 will be described below with reference to FIG. 14, FIG. 15, FIG. 16, and FIG. 17. FIG. 14 shows the state before the simulation is executed, and FIG. 15, FIG. 16, and FIG. 17 show the state after the simulation is executed. Here, it is assumed that a dirt model 100 that is assumed to be removed by jetting 3 ml of fluid is adhered to the dirt adhering model 95.

Also, P1 to P6 represent teaching points, and it is assumed that the hand reference point of the cleaning robot model 70, in other words, the jet model is sequentially moved from P1 to P6. Note that, as shown in FIG. 14, when simulation of the cleaning robot model 70 is executed or a teaching point is taught, it is desirable to display the jet model 300. Accordingly, it is possible to intuitively grasp whether or not the fluid is being jetted to the dirt model 100.

As shown in FIG. 15, when, as a result of executing the simulation, some of the dirt models 100 adhered to the dirt adhering model 95 remain unchanged in the display mode, it means that fluid is not jetted to part of the dirt. By confirming that some of the dirt models 100 remain unchanged in the display mode, the user can take measures such as modifying the teaching point so that the fluid can be jetted to those some of the dirt models 100.

As shown in FIG. 16, when all of the dirt models 100 adhered to the dirt adhering model 95 only change their display modes and remain as a result of executing the simulation, it means that the fluid is jetted onto the dirt, but the jet amount is insufficient. The user can grasp the need to increase the jet amount by confirming the change in the display mode of the dirt model 100, and can take measures such as modifying the cleaning program so as to slow down the moving speed or adopting a cleaning nozzle that increases the jet amount.

As shown in FIG. 17, when all of the dirt models 100 adhered to the dirt adhering model 95 are deleted as a result of executing the simulation, it means that the cleaning has been properly performed. By confirming that all the dirt models 100 have been deleted, the user can grasp that the cleaning program has been properly created.

According to the simulation apparatus 1 of the present embodiment, it is possible to create and display a dirt adhering model in which dirt is reflected on a cleaning target model. For example, in the dirt adhering model, dirt is expressed by adding a dirt model to a cleaning target model, and dirt is expressed by changing the display mode of the surface of the cleaning target model. The dirt represented by the dirt adhering model is displayed so that the degree of dirt can be understood by color. In the simulation, the jet amount of fluid to be jetted to the dirt represented by the dirt adhering model is calculated, the jet amount is subtracted from the degree of dirt, the display mode of the dirt expressed on the cleaning target model is changed in accordance with the degree of dirt after the subtraction, or the dirt expressed on the cleaning target model can be deleted when the degree of dirt becomes 0. Since the dirt reflected on the dirt adhering model can be visually grasped, the user can intuitively register the teaching point. In addition, the change in the display mode of dirt reflected on the dirt adhering model and the deletion of the dirt allow the user to actually see the dirt disappear, making it possible to create a cleaning program with the same procedures and sensations as actually trying it out on the actual machine.

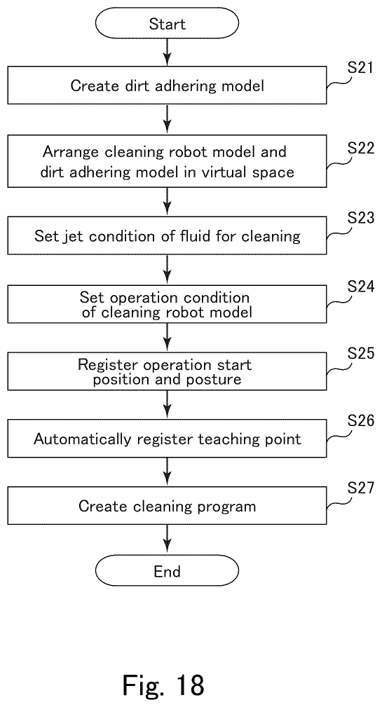

An example of a procedure for automatically creating the cleaning program using the simulation apparatus 1 according to the present embodiment will be described below with reference to FIG. 18. FIG. 18 is a flowchart showing a procedure for automatically creating the cleaning program using the simulation apparatus 1 according to the present embodiment. Steps S21 to S24 in FIG. 18 correspond to steps S11 to S14 in FIG. 4, respectively, and descriptions thereof will be omitted.

As shown in FIG. 18, when the creation of the dirt adhering model (S21), the arrangement of the model in the virtual space (S22), and the setting of various conditions (S23, S24) are completed, the simulation apparatus 1 registers the operation start position and posture of the cleaning robot based on a user operation on the teaching screen (S25). Next, the simulation apparatus 1 automatically registers teaching points one after another (S26). Then, the simulation apparatus 1 creates a cleaning program using the jet condition set in step S23, the operation condition set in step S24, the start point recorded in step S25, and the teaching points automatically registered in step S26 (S26), and completes the automatic generation processing of the cleaning program.

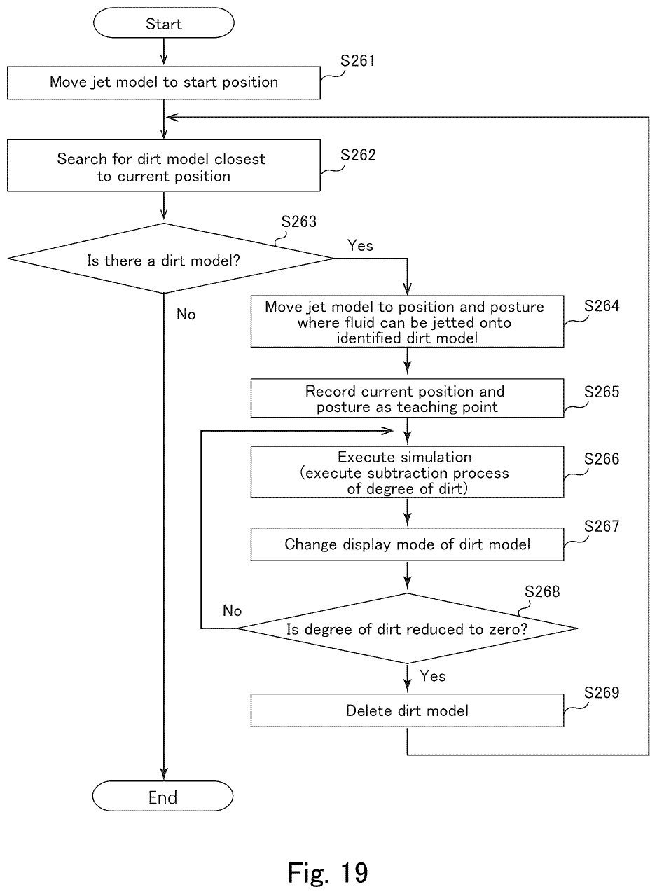

With reference to FIG. 19, the procedure of the automatic registration process of the teaching point in step S26 of FIG. 18 will be described below. FIG. 19 is a flowchart showing an example of a procedure of the automatic registration process of the teaching point using the simulation apparatus 1 according to the present embodiment.

As shown in FIG. 19, the jet model is moved to the operation start position and posture registered in step S25 of FIG. 18 by simulation (S261). Next, a dirt model located closest to the current position is searched (S262). When there is a dirt model (S263; Yes), the jet model is moved to a position and posture where fluid can be jetted to the dirt model (S264), and the current position and posture after the jet model is moved are registered as a teaching point (S265). Then, as the jetting simulation is executed (S266), the display mode of the dirt model is changed (S267). Specifically, a process of subtracting the jet amount of fluid jetted from the jet model from the degree of dirt of the dirt model hit by the fluid jetted from the jet model is executed, and in parallel, the display mode of the dirt model is changed in accordance with the degree of dirt. The jet simulation is executed until the degree of dirt of the dirt model becomes 0 (S268; No). When the degree of dirt of the dirt model becomes 0 (S268; Yes), the dirt model is deleted (S269). The processes of steps S262 to S269 are repeatedly executed until there is no dirt model, that is, until the cleaning of the dirt adhering model is completed, and the same number of teaching points as the number of repetitions are registered. Based on all of the dirt models added to the dirt adhering model having been deleted, the teaching point automatic registration process in step S26 of FIG. 18 is completed.

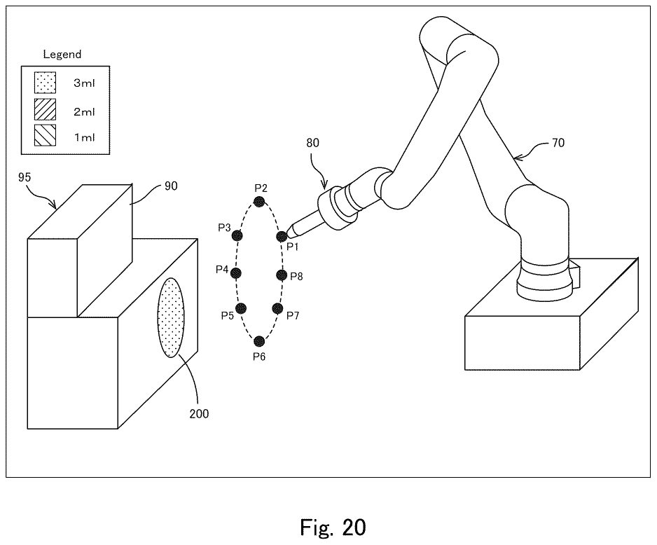

The automatic creation of the cleaning program described with reference to FIG. 19 is highly flexible and can be applied to the creation of cleaning programs of various dirt adhering models. On the other hand, teaching points may be automatically registered in accordance with the shape and size of the range of dirt. FIG. 20 is a diagram for explaining another example of the teaching point automatic registration process using the simulation apparatus 1 according to the present embodiment. As shown in FIG. 20, when the dirt adhering model 95 has a circular dirt range 200, a plurality of teaching points P1 to P8 from which fluid can be jetted to the dirt range 200 and which are along the circumference of a circle having a shape similar to the dirt range 200 are automatically registered. Thus, the moving path of the jet model 300 may be registered in accordance with the shape of the dirt range 200 reflected on the dirt adhering model 95, thereby allowing the moving path to be automatically determined in accordance with the shape of the dirt range 200.

The following appendixes are further disclosed with respect to the present embodiments and modifications.

### Appendix 1

A simulation apparatus 1 comprises a storage unit 18 for storing a 3D model 90 of a workpiece to be cleaned, a reception unit 15 for receiving a user operation for causing dirt to be expressed on entirety or part of the 3D model of the workpiece, a model creation unit 21 for creating, based on a user operation, a dirt adhering model 95 in which the dirt is expressed on the entirety or part of the 3D model 90 of the workpiece, and a display unit 16 for displaying the created dirt adhering model 95.

### Appendix 2

The dirt described in Appendix 1 is added to the 3D model 90 of the workpiece as a dirt model 100, and is displayed on the 3D model 90 of the workpiece.

### Appendix 3

The dirt model 100 described in Appendix 2 includes information on a degree of dirt, and a display mode of the dirt model 100 is changed depending on the degree of dirt.

### Appendix 4

The dirt model 100 described in Appendix 2 includes information on a degree of dirt, and is displayed with the information on the degree added thereto.

### Appendix 5

The dirt model 100 described in any one of Appendixes 2 to 4 is represented by a spherical or cubic shape.

### Appendix 6

The simulation apparatus 1 described in Appendix 2 further comprises a jet model moving unit 70 for moving a fluid jet model with respect to the 3D model 90 of the workpiece, and a jet amount calculation unit 30 for calculating a jet amount of the jet model 300 for each part of the 3D model 90 of the workpiece, and the model creation unit 21 individually removes the dirt model 100 added to the entirety or part of the 3D model 90 of the workpiece based on the calculated jet amount.

### Appendix 7

In the simulation apparatus 1 described in Appendix 6, the jet model moving unit 70 further includes a program creation unit 29 for moving the jet model 300 in order to arrange the dirt model 100 in a jet distribution of the jet model 300 and creating a cleaning program based on a position of the jet model 300 after the movement.

### Appendix 8

In the simulation apparatus 1 described in Appendix 1, a surface color of the entirety or part of the 3D model 90 of the workpiece is changed from a first color to a second color as the dirt.

### Appendix 9

The second color described in Appendix 8 is changed depending on a degree of dirt.

### Appendix 10

The simulation apparatus 1 described in Appendix 8 or Appendix 9 further comprises a jet model moving unit 70 for moving a fluid jet model to the 3D model 90 of the workpiece, and a jet amount calculation unit 30 for calculating a jet amount of the jet model for each part of the 3D model 90 of the workpiece, and the surface color of the entirety or part of the 3D model 90 of the workpiece is approximated from the second color to the first color based on the calculated jet amount.

### Appendix 11

The jet model moving unit 70 described in Appendix 10 further includes a program creation unit 29 for moving the jet model 300 in order to arrange the entirety or part of the 3D model 90 of the workpiece expressed by the second color in a jet distribution of the jet model 300, and creating a cleaning program based on a position of the jet model 300 after the movement.

### Appendix 12

A program causes a computer storing a 3D model 90 of a workpiece to be cleaned to implement: means 15 for receiving a user operation for causing dirt to be expressed on entirety or part of the 3D model 90 of the workpiece, means 21 for creating, based on a user operation, a dirt adhering model 95 in which the dirt is expressed on the entirety or part of the 3D model 90 of the workpiece, and means 16 for displaying the created dirt adhering model 95.

While embodiments of the present disclosure have been described in detail, the present disclosure is not limited to the individual embodiments described above. These embodiments may be subjected to various additions, substitutions, modifications, partial deletions, etc., without departing from the gist of the invention or the idea and spirit of the present invention as derived from the contents described in the claims and their equivalents. For example, in the above-described embodiments, the order of the operations and the order of the processes are shown as examples, and the present invention is not limited thereto. The same applies to the case where numerical values or formulas are used in the description of the above-described embodiments.

1. A simulation apparatus comprising:
a storage unit for storing a 3D model of a workpiece to be cleaned;
a reception unit for receiving a user operation for causing dirt to be expressed on entirety or part of the 3D model of the workpiece;
a model creation unit for creating, based on a user operation, a dirt adhering model in which the dirt is expressed on the entirety or part of the 3D model of the workpiece; and
a display unit for displaying the created dirt adhering model.

2. The simulation apparatus according to claim 1, wherein the dirt is added to the 3D model of the workpiece as a dirt model, and is displayed on the 3D model of the workpiece.

3. The simulation apparatus according to claim 2, wherein the dirt model includes information on a degree of dirt, and a display mode of the dirt model is changed depending on the degree of dirt.

4. The simulation apparatus according to claim 2, wherein the dirt model includes information on a degree of dirt, and is displayed with the information on the degree added thereto.

5. The simulation apparatus according to claim 2, wherein the dirt model is represented by a spherical or cubic shape.

6. The simulation apparatus according to claim 2 further comprising:
a jet model moving unit for moving a fluid jet model with respect to the 3D model of the workpiece; and
a jet amount calculation unit for calculating a jet amount of the jet model for each part of the 3D model of the workpiece, wherein
the model creation unit individually removes the dirt model added to the entirety or part of the 3D model of the workpiece based on the calculated jet amount.

7. The simulation apparatus according to claim 6, wherein the jet model moving unit further includes a program creation unit for moving the jet model in order to arrange the dirt model in a jet distribution of the jet model and creating a cleaning program based on a position of the jet model after the movement.

8. The simulation apparatus according to claim 1, wherein a surface color of the entirety or part of the 3D model of the workpiece is changed from a first color to a second color as the dirt.

9. The simulation apparatus according to claim 8, wherein the second color is changed depending on a degree of dirt.

10. The simulation apparatus according to claim 8, further comprising:
a jet model moving unit for moving a fluid jet model with respect to the 3D model of the workpiece; and
a jet amount calculation unit for calculating a jet amount of the jet model for each part of the 3D model of the workpiece, wherein
the surface color of the entirety or part of the 3D model of the workpiece is approximated from the second color to the first color based on the calculated jet amount.

11. The simulation apparatus according to claim 10, wherein
the jet model moving unit further includes a program creation unit for moving the jet model in order to arrange the entirety or part of the 3D model of the workpiece expressed by the second color in a jet distribution of the jet model and creating a cleaning program based on a position of the jet model after the movement.

12. A non-transitory storage medium storing a program for causing a computer storing a 3D model of a workpiece to be cleaned to implement:
receiving a user operation for causing dirt to be expressed on entirety or part of the 3D model of the workpiece;
creating, based on a user operation, a dirt adhering model in which the dirt is expressed on the entirety or part of the 3D model of the workpiece; and
displaying the created dirt adhering model.
